(19) United States
(12) Patent Application Publication
(10) Pub. No.: US 2023/0084938 A1
(43) Pub. Date: Mar. 16, 2023

(54) ANIMAL SUCTION FOOTBATH DEVICE

(71) Applicant: Guadalupe Flores Melendrez, Kerman, CA (US)

(72) Inventor: Guadalupe Flores Melendrez, Kerman, CA (US)

(21) Appl. No.: 17/477,085

(22) Filed: Sep. 16, 2021

(51) Int. Cl. A01K 13/00; A47L 7/00

(52) U.S. Cl. CPC A01K 13/001; A47L 7/0004

(57) ABSTRACT

An animal suction footbath device, including a main body to receive at least one foot of an animal therein, the main body including a base, and a plurality of walls angularly disposed away from a perimeter of the base to prevent a liquid from moving off the base, a treatment dispensing pipe longitudinally disposed along a center of the base, a plurality of treatment dispensing pipes longitudinally disposed along at least one edge of the base, each of plurality of treatment dispensing pipes including a plurality of liquid apertures longitudinally disposed along a length of each of the plurality of treatment dispensing pipes to expel the liquid therefrom in a lateral direction toward at least one of the plurality of walls and the at least one foot of the animal, and a plurality of connector pipes disposed on at least a portion of the plurality of walls and connected to at least one of the plurality of treatment dispensing pipes to direct the liquid to the plurality of treatment dispensing pipes.

### BACKGROUND

### 1. Field

The present general inventive concept relates generally to preventing animal infection, and particularly, to an animal suction footbath device.

### 2. Description of the Related Art

A foot bath is one of the most important tools used on a farm to prevent lameness and maintain health of a hoof of an animal. When used properly and paired with a disinfectant, the foot bath can prevent and control foot rot and digital dermatitis on cattle. Additionally, many disinfectants such as formaldehyde are commonly used in the foot bath for the cattle along with other chemicals that are often considered a carcinogen and irritant.

Most current models of the foot bath will prevent invention of the hooves using an intense spraying action and pressure. However, the spray causes splash which leaves remnants of the disinfectant particles on the animal's and/or farm worker's skin and eyes. The potential for serious health risks on both the cattle and farm workers is severe.

Therefore, there is a need for other an infection preventing device that treats the foot of the animal without causing splash and removes waste water safely.

### SUMMARY

The present general inventive concept provides an animal suction footbath device.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing an animal suction footbath device, including a main body to receive at least one foot of an animal therein, the main body including a base, and a plurality of walls angularly disposed away from a perimeter of the base to prevent a liquid from moving off the base, a plurality of treatment dispensing pipes longitudinally disposed along at least one edge of the base, each of plurality of treatment dispensing pipes including a plurality of liquid apertures longitudinally disposed along a length of each of the plurality of treatment dispensing pipes to expel the liquid therefrom in a lateral direction toward at least one of the plurality of walls and the at least one foot of the animal, and a plurality of connector pipes disposed on at least a portion of the plurality of walls and connected to at least one of the plurality of treatment dispensing pipes to direct the liquid to the plurality of treatment dispensing pipes.

The animal suction footbath device may further include a textured surface disposed on at least a portion of the base to increase a friction level thereon.

Each end of the treatment dispensing pipe may be square shaped to prevent it from moving on the base.

The animal suction footbath device may further include a feeding pipe circumferentially disposed around an edge of each of the plurality of walls to facilitate movement of the liquid into each of the plurality of connector pipes.

The animal suction footbath device may further include a plurality of liquid extraction pipes disposed on at least a portion of the main body to extend from the base and curve over at least one of the plurality of walls.

The animal suction footbath device may further include a plurality of auxiliary pipes disposed on at least a portion of the base to connect to a hose to receive and disperse the liquid.

The animal suction footbath device may further include a cover plate removably connected to at least a portion of the main body to prevent at least one object from falling within the main body.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a perspective view of an animal suction footbath device, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Animal Suction Footbath Device 100
Main Body 110
Base 111
Walls 112
Textured Surface 113
Treatment Dispensing Pipes 120
Liquid Apertures 121
Plugs 122
Feeding Pipe 130
Connector Pipes 140
Liquid Extraction Pipes 150
Auxiliary Pipes 160
Connecting Aperture 161
Heater 170
Cover Plate 180

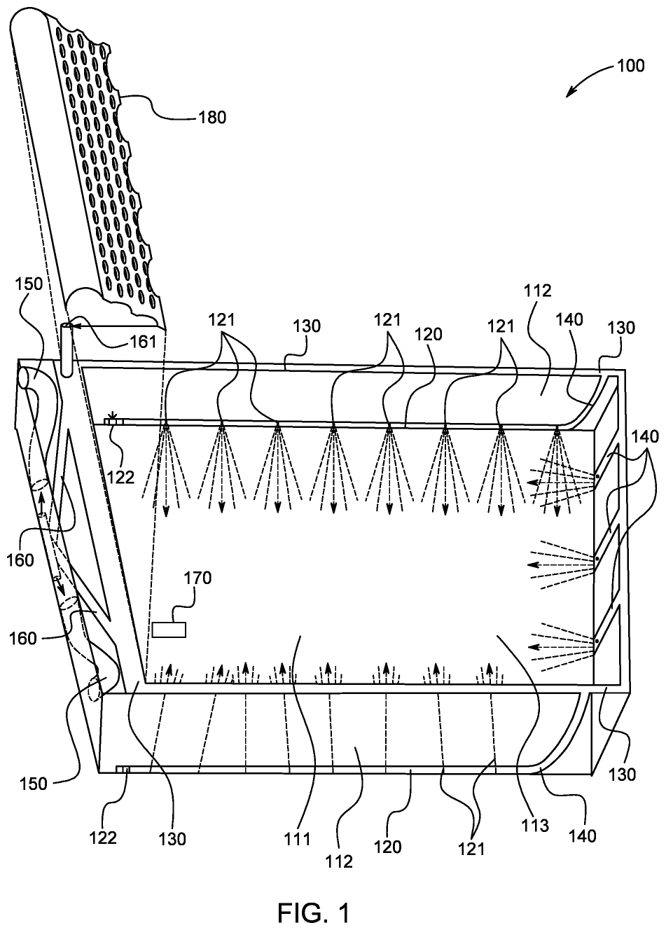

FIG. 1 illustrates a perspective view of an animal suction footbath device 100, according to an exemplary embodiment of the present general inventive concept.

The animal suction footbath device 100 may be constructed from at least one of metal, plastic, wood, glass, and rubber, etc., but is not limited thereto.

The animal suction footbath device 100 may include a main body 110, a plurality of treatment dispensing pipes 120, a feeding pipe 130, a plurality of connector pipes 140, a plurality of liquid extraction pipes 150, a plurality of auxiliary pipes 160, a heater 170, and a cover plate 180, but is not limited thereto.

Referring to FIG. 1, the main body 110 is illustrated to have a rectangular prism shape. However, the main body 110 may be rectangular, circular, conical, triangular, pentagonal, hexagonal, heptagonal, octagonal, or any other shape known to one of ordinary skill in the art, but is not limited thereto. Also, the main body 110 may be constructed of stainless steel.

The main body 110 may have a size corresponding to a size of an animal, such as cattle. In other words, the main body 110 may fit at least one foot (i.e. hoof) of the animal therein. However, the main body 110 may fit each foot of the animal therein, such that an entire body of the animal is within the main body 110 during use, such that the animal is able to fully stand within the main body 110. The main body 110 may store a liquid therein. For example, the main body 110 may store the liquid, such as water, chemicals (e.g., formaldehyde, copper sulfate), disinfectant, soap, gel, shampoo, and/or any combination thereof, but is not limited thereto.

The main body 110 may include a base 111, a plurality of walls 112, and a textured surface 113, but is not limited thereto.

Furthermore, the plurality of walls 112 may be beveled with respect to the base 111 of the main body 110, such that the plurality of walls 112 may be angularly disposed away from a perimeter of the base 111 with respect to a direction. As such, the main body 110 may have extra space at a top portion thereof to fit the animal therein. The plurality of walls 112 may prevent the liquid from moving off the base 111.

The textured surface 113 may include a rubber surface, a mesh, a gritted surfaced (e.g., sandpaper), and a knurled surface, but is not limited thereto.

The textured surface 113 may be disposed on at least a portion of the base 111 of the main body 110. Moreover, the textured surface 111 may increase a friction level thereon, such that the textured surface 113 may prevent the at least one foot from slipping.

Each of the plurality of treatment dispensing pipes 120 may include a plurality of liquid apertures 121 and a plurality of plugs 122, but is not limited thereto.

Each of the plurality of treatment dispensing pipes 120 may be longitudinally disposed along a first edge and/or a second edge of the base 111 opposite with respect to the first edge of the base 111 of the main body 110. Each of the plurality of treatment dispensing pipes 120 may be a rectangular prism shape to prevent it from moving (i.e. rolling) away from the base 111 of the main body 110. However, each end (i.e. a first end, a second end) of each of the plurality of treatment dispensing pipes 120 may have a square shape with respect to an elevational view thereof, such that each end of each of plurality of treatment dispensing pipes 120 may also prevent the main body 110 from moving.

The plurality of liquid apertures 121 may be longitudinally disposed along a length of each of the plurality of treatment dispensing pipes 120 on a first side and/or a second side of each of the plurality of treatment dispensing pipes 120 opposite with respect to the first side. Moreover, the plurality of liquid apertures 121 may be distanced from each other. The plurality of liquid apertures 121 may expel the liquid therefrom. For example, the plurality of liquid apertures 121 may expel the liquid in a lateral direction toward at least one of the plurality of walls 112 of the main body 110, such that the liquid may move on a same plane as the plurality of liquid apertures 121. As such, the plurality of liquid apertures 121 may project the liquid onto the foot of the animal, such that the foot may be treated. In other words, the plurality of treatment dispensing pipes 120 may expel the liquid on the foot of the animal apply the liquid (e.g., water, chemicals) to prevent infections on the foot of the animal, such as fungi. It is important to note that the plurality of liquid apertures 121 are positioned and/or oriented to prevent spilling and/or splash of the liquid during use. For example, the plurality of liquid apertures 121 may be oriented toward the base 111.

The plurality of plugs 122 may be removably connected to at least a portion of an end of each of the plurality of treatment dispensing pipes 120. The plurality of plugs 122 may prevent the liquid from being extracted and/or expelled through the end of each of the plurality of treatment dispensing pipes 120. The plurality of plugs 122 may be removed to facilitate extracting the liquid during cleaning of the plurality of treatment dispensing pipes 120.

The feeding pipe 130 may be circumferentially disposed around an edge of each of the plurality of walls 112 of the main body 110. In other words, the feeding pipe 130 may be disposed around a perimeter of the main body 110 along the plurality of walls 112.

The plurality of connector pipes 140 may be disposed on at least a portion of the plurality of walls 112 of the main body 110. In other words, each of the plurality of walls 112 may have at least one of the plurality of connector pipes 140 disposed thereon. Each of the plurality of connector pipes 140 may connect the feeding pipe 130 to the treatment dispensing pipe 120. As such, the plurality of liquid apertures 121 may expel the liquid therefrom in response to receiving the liquid through each of the plurality of treatment dispensing pipes 120. Accordingly, the plurality of liquid apertures 121 may facilitate treatment of the foot of the animal.

The plurality of liquid extraction pipes 150 may have any size based on a preference of a user and/or a manufacturer. For example, the plurality of liquid extraction pipes 150 may have a diameter of one and half inches.

Referring again to FIG. 1, the plurality of liquid extraction pipes 150 may be disposed on at least a portion of the main body 110. Additionally, the plurality of liquid extraction pipes 150 may extend from the base 111 to curve over at least one of the plurality of walls 112, such that the liquid may be expelled therefrom.

Each of the plurality of auxiliary pipes 160 may include a connecting aperture 161, but is not limited thereto.

The plurality of auxiliary pipes 160 may be disposed on at least a portion of the base 111 of the main body 110 and connected to the plurality of liquid extraction pipes 150. The plurality of auxiliary pipes 160 may facilitation extraction of water from the base 111 toward the plurality of liquid extraction pipes 150, such that dirty liquid and/or waste water may be expelled from within the main body 110 through the plurality of liquid extraction pipes 150.

The connecting aperture 161 may receive and/or connect to a hose 10 from an external liquid pressure tank and disperse the liquid to the plurality of treatment dispensing pipes 120, the feeding pipe 130, the plurality of connector pipes 140, and/or the plurality of liquid extraction pipes 150. Moreover, the connecting aperture 161 may direct the liquid, such as water, to flow therethrough into the feeding pipe 130 into each of the plurality of connector pipes 140 toward the plurality of treatment dispensing pipes 120.

The heater 170 may include a water heater, an activation switch, and a power source (e.g., a power inlet, a battery, a solar cell, etc.), but is not limited thereto.

The heater 170 may be disposed on at least a portion of the base 111. The heater 170 may increase a temperature level of the liquid in response to being turned on using the activation switch. In other words, the heater 170 may heat up the liquid. As such, the heater 170 may facilitate cleaning of the at least one foot of the animal and/or cleaning of the main body 110.

The cover plate 180 may include a plurality of ventilation apertures, but is not limited thereto.

The cover plate 180 may be removably connected to at least a portion of the main body 110. Moreover, the cover plate 180 may removably connect to at least a portion of the plurality of walls 112 within the main body 110. The cover plate 180 may prevent at least one object from falling within the main body 110. However, the plurality of ventilation apertures may facilitate evaporation and/or release of an odor within the main body 110.

Therefore, the animal suction footbath device 100 may avoid the problems of spraying the foot of the animal, such as release of chemicals onto the skin and/or eyes of the animal and/or a user. Also, the animal suction footbath device 100 may easily remove the liquid within the main body 110 without exposure to the user.

The present general inventive concept may include an animal suction footbath device 100, including a main body 110 to receive at least one foot of an animal therein, the main body 110 including a base 111, and a plurality of walls 112 angularly disposed away from a perimeter of the base 111 to prevent a liquid from moving off the base 111, a plurality of treatment dispensing pipes 120 longitudinally disposed along at least one edge of the base 111, each of plurality of treatment dispensing pipes 120 including a plurality of liquid apertures 121 longitudinally disposed along a length of each of the plurality of treatment dispensing pipes 120 to expel the liquid therefrom in a lateral direction toward at least one of the plurality of walls 112 and the at least one foot of the animal, and a plurality of connector pipes 140 disposed on at least a portion of the plurality of walls 112 and connected to at least one of the plurality of treatment dispensing pipes 120 to direct the liquid to the plurality of treatment dispensing pipes 120.

The animal suction footbath device 100 may further include a textured surface 113 disposed on at least a portion of the base 111 to increase a friction level thereon.

Each end of the treatment dispensing pipe 120 may be square shaped to prevent it from moving on the base 111.

The animal suction footbath device 100 may further include a feeding pipe 130 circumferentially disposed around an edge of each of the plurality of walls 112 to facilitate movement of the liquid into each of the plurality of connector pipes 140.

The animal suction footbath device 100 may further include a plurality of liquid extraction pipes 150 disposed on at least a portion of the main body 110 to extend from the base 111 and curve over at least one of the plurality of walls 112.

The animal suction footbath device 100 may further include a plurality of auxiliary pipes 160 disposed on at least a portion of the base 111 to connect to a hose 10 to receive and disperse the liquid.

The animal suction footbath device 100 may further include a cover plate 180 removably connected to at least a portion of the main body 110 to prevent at least one object from falling within the main body 110.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. An animal suction footbath device, comprising:
a main body to receive at least one foot of an animal therein, the main body comprising:
a base, and
a plurality of walls angularly disposed away from a perimeter of the base to prevent a liquid from moving off the base;
a plurality of treatment dispensing pipes longitudinally disposed along at least one edge of the base, each of plurality of treatment dispensing pipes comprising:
a plurality of liquid apertures longitudinally disposed along a length of each of the plurality of treatment dispensing pipes to expel the liquid therefrom in a lateral direction toward at least one of the plurality of walls and the at least one foot of the animal; and
a plurality of connector pipes disposed on at least a portion of the plurality of walls and connected to at least one of the plurality of treatment dispensing pipes to direct the liquid to the plurality of treatment dispensing pipes.

2. The animal suction footbath device of claim 1, further comprising:
a textured surface disposed on at least a portion of the base to increase a friction level thereon.

3. The animal suction footbath device of claim 1, wherein each end of the plurality of treatment dispensing pipes is square shaped to prevent it from moving on the base.

4. The animal suction footbath device of claim 1, further comprising:
a feeding pipe circumferentially disposed around an edge of each of the plurality of walls to facilitate movement of the liquid into each of the plurality of connector pipes.

5. The animal suction footbath device of claim 1, further comprising:
a plurality of liquid extraction pipes disposed on at least a portion of the main body to extend from the base and curve over at least one of the plurality of walls.

6. The animal suction footbath device of claim 1, further comprising:
a plurality of auxiliary pipes disposed on at least a portion of the base to connect to a hose to receive and disperse the liquid.

7. The animal suction footbath device of claim 1, further comprising:
a cover plate removably connected to at least a portion of the main body to prevent at least one object from falling within the main body.
